(19) United States
(12) Patent Application Publication
(10) Pub. No.: US 2016/0084322 A1
(43) Pub. Date: Mar. 24, 2016

(54) DOUBLE WET CLUTCH MECHANISM FOR A TRANSMISSION SYSTEM

(71) Applicant: VALEO EMBRAYAGES, Amiens Cedex (FR)

(72) Inventors: Rabah ARHAB, Saint-Brice-Sous-Foret (FR); Herve RIBOT, Peronne (FR); Laurent CAUMARTIN, Beauquesne (FR)

(21) Appl. No.: 14/856,756

(22) Filed: Sep. 17, 2015

(30) Foreign Application Priority Data
Sep. 18, 2014 (FR) 1458830

(51) Int. Cl. F16D 13/38; F16D 13/72; F16D 13/74; F16D 13/52

(52) U.S. Cl. CPC F16D 13/385; F16D 13/52; F16D 13/72; F16D 13/74

(57) ABSTRACT

A double wet clutch mechanism for a transmission system, at least a first clutch and a second clutch respectively of the multiple-disc type, the first clutch having a first piston and the second clutch having a second piston, the first and second pistons being displaced in order to cause, in an engaged position, clamping of a multiple-disc assemblage against reaction means that are interposed axially between the multiple-disc assemblage of each of the first and second clutches, the assemblage respectively having friction discs that are rotationally connected respectively to the first driven shaft and to the second driven shaft respectively by an external disc carrier, each of the external disc carriers having a radial extension and an axial extension, the axial extension of one of the external disc carriers exhibiting a radial offset.

### CROSS-REFERENCE TO RELATED APPLICATIONS AND CLAIM TO PRIORITY

This application claims priority to Patent Application No. 1458830 filed Sep. 18, 2014 in France, the disclosure of which is incorporated herein by reference and to which priority is claimed.

### FIELD OF THE INVENTION

The present invention relates to a double wet clutch mechanism for a transmission system.

The present invention relates more particularly to a double wet clutch mechanism for a transmission system, especially for a motor vehicle, having around a rotation axis at least a first clutch and a second clutch respectively of the multiple-disc type, the first clutch having at least a first piston and the second clutch having at least a second piston, said first and second pistons being displaced axially in opposite directions in order to cause, in an engaged position, clamping of a multiple-disc assemblage against reaction means.

### BACKGROUND OF THE INVENTION

A double clutch mechanism of this kind for a transmission system, especially of a motor vehicle, is known from the existing art.

A distinction is made in particular between two double clutch mechanism designs: on the one hand so-called double “dry” clutch mechanisms, and on the other hand so-called double “wet” clutch mechanisms.

The present invention relates more particularly to a double wet clutch.

In the case of a double wet clutch mechanism, the clutches are generally of the multiple-disc type, and the friction linings of the discs of the multiple-disc assemblage are kept constantly wet by oil.

The transmission system having said double wet clutch mechanism generally has at least an input shell that is rotationally connected to a driving shaft and to a drive web in order to rotationally connect said input shell to said mechanism, which mechanism is controlled to selectively couple said driving shaft to a first driven shaft and to a second driven shaft.

In order to do so, the double clutch mechanism has a first clutch, arranged for example on the gearbox side, that serves both for starting and for engagement of the odd-numbered ratios, and a second clutch, arranged for example on the engine side, that handles the even-numbered ratios and the reverse gear.

The first clutch and the second clutch alternatively transmit input power (torque and speed) from the driving shaft, which is rotationally connected to the engine, to one of the two driven shafts that are connected to the gearbox and are generally coaxial.

For increased safety, the first clutch and the second clutch of the mechanism are respectively disengaged when at rest, i.e. are “normally open,” and are actively closed by hydraulic actuating means of a control device that is associated with the double clutch mechanism.

The increasing attention being paid to double clutch mechanisms has to do in particular with the comfort and performance obtained, as well as continuous acceleration during gear changes with no interruption in torque.

Transmission systems having a double clutch mechanism of this kind also provide a benefit in terms of consumption and CO₂ emission as compared especially with a traditional automatic gearbox.

For certain applications, the first clutch and the second clutch of the double wet clutch mechanism are axially juxtaposed, arranged alongside one another, and the pistons of each of said first and second clutches are displaced axially in opposite directions in order to come into an engaged position.

The reaction means of the first clutch and of the second clutch are then interposed axially between the multiple-disc assemblage of the first clutch and the multiple-disc assemblage of the second clutch.

The multiple-disc assemblage of the first clutch and the multiple-disc assemblage of the second clutch are axially at a distance from the rotation axis.

The multiple-disc assemblage of first clutch E1 and of second clutch E2 respectively has friction discs that are rotationally connected respectively to first driven shaft A1 and to second driven shaft A2 respectively by an external disc carrier that constitutes the output element of the clutch. Each external disc carrier has a radial extension and an axial extension. The axial extension of each of the external disc carriers extends along an axis parallel to the rotation axis.

This arrangement of the multiple-disc assemblages of the first clutch and of the second clutch causes increased inertia. Such inertia can result in premature wear on the double clutch or even a malfunction of such a double clutch. Such an arrangement is moreover bulky.

A double wet clutch mechanism of this kind for a transmission system is consequently not entirely satisfactory, especially in terms of operating reliability.

### SUMMARY OF THE INVENTION

The object of the present invention is in particular to propose a double wet clutch mechanism for a transmission system which allows at least some of the problems of the existing art, in particular reliability, to be resolved.

To that end, the invention proposes a double wet clutch mechanism of the type described previously, in which the axial extension of at least one of said external disc carriers exhibits a radial offset.

Advantageously, the radial offset allows an appreciable reduction in the inertia of the multiple-disc assemblage, and a reduction in the radial space requirement of the clutch.

According to other characteristics of the invention:
The external disc carrier of the second clutch is received inside the external disc carrier of the first clutch, the external disc carrier of the first clutch having said axial extension with the radial offset.
The axial extension of the external disc carrier, exhibiting an axial offset, has a first portion and a second portion each inscribed respectively within a first cylinder and within a second cylinder, the radius R1 of the first portion being larger than the radius R2 of the second portion.
The first portion and the second portion form a single part.

Advantageously, a section of frustoconical shape is thus formed locally along the axial extension, the section of said frustoconical shape tapering with increasing distance from the radial extension.
The first portion and the second portion each constitute a separate part, said portions being rotationally connected, for example by welding or riveting. The second portion is connected to the first portion while being offset radially toward the rotation axis with respect to the first portion. A two-portion axial extension of this kind allows for portions having different thicknesses with respect to one another. The inertia and force on the portion farthest from the radial extension can thus be more easily controlled.
An end of the first portion and an end of the second portion each constitute a radial collar, the collar of the first portion and the collar of the second portion being rotationally connected to one another.
An end of the first portion and an end of the second portion each constitute a peripheral rim extending axially, the peripheral rim of the first portion and the peripheral rim of the second portion being rotationally connected to one another by superposition of their respective peripheral rims. The connection between these two rims is such that the second portion is offset radially with respect to the first portion.
The radius R2 of the second portion is reduced to a value corresponding to a clearance J measured between the two external disc carriers at the location of the second portion of the axial extension, the clearance J being sufficient to permit one of the external disc carriers to slide onto the other of the external disc carriers during assembly. More precisely, the tooth sets of the external disc carrier that is farthest from the rotation axis are inserted through a complementary tooth set of the other of the external disc carriers with a slight clearance J at the time of assembly.
The axial extension of the external disc carrier has at least one stiffening means for stiffening said extension.

Because the extension is implemented in two portions, the near portion of the radial extension can be reduced to a minimum thickness. Its rigidity can be reinforced by the presence of stiffening means on that same portion. It is thus possible to decrease the thickness and inertia of the clutch.
The axial extension constitutes at least one local deformation extending in a direction opposite to the rotation axis.
The local deformation is at least partly annular.
The axial extension has a splined outer peripheral surface.
The axial extension has at least one opening.

The inertia of the mechanism can thus be reduced further.

Also an object of the invention is a double wet clutch mechanism of the type described previously, in which the axial extension of at least one of the two external disc carriers of at least one of the two clutches has a first portion and a second portion that each constitute a separate part, the second portion serving as a support for the discs, the portions being rotationally connected to one another.

The second portion can be offset radially with respect to the first portion, or can be located along the same axis as that of the first portion. A two-portion axial extension of this kind thus allows for portions having different thicknesses from one another. The inertia and force on the portion farthest from the radial extension can thus be more easily controlled.

At least one opening in at least one of the portions can be provided. Advantageously, the opening is effected in the first portion that is connected to the radial extension.

### BRIEF DESCRIPTION OF THE DRAWINGS

Other characteristics and advantages of the invention will emerge upon reading the detailed description below, which will be understood upon reference to the attached drawings in which:

FIG. 1 is an axial half section view that depicts a transmission system having a double wet clutch mechanism and that illustrates an embodiment of the reaction means, according to the invention;

FIG. 2 is an axial half section view offset angularly with respect to that of FIG. 1;

FIGS. 3A and 3B are respectively a section view and a three-dimensional view of a disc carrier of the first clutch, according to the invention;

FIGS. 4A and 4B are respectively a section view and a three-dimensional view of the disc carrier of the first clutch, according to a variant of the invention;

FIG. 5 is a three-dimensional view of the disc carrier of the first clutch, according to a variant of the invention;

FIGS. 6A and 6B are respectively a section view and a three-dimensional view of the disc carrier of the first clutch, according to another variant of the invention; and

FIGS. 7A and 7B are respectively an axial section view and cross-sectional view of the disc carrier of the transmission system, according to the invention.

### DETAILED DESCRIPTION OF THE PREFERRED EMBODIMENT(S)

In the description below and in the claims, the terms “front” or “rear” will be used, in non-limiting fashion and in order to facilitate understanding, in accordance with the direction with respect to an axial orientation determined by rotation axis O, as well as the terms “internal/inner” or “external/outer” with respect to axis O and in accordance with a radial orientation orthogonal to said axial orientation.

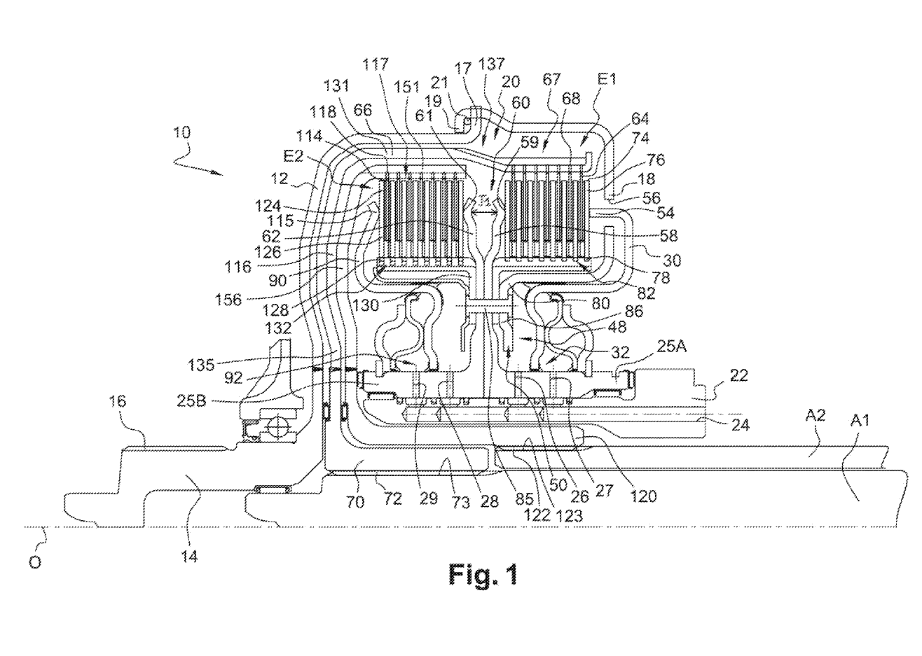

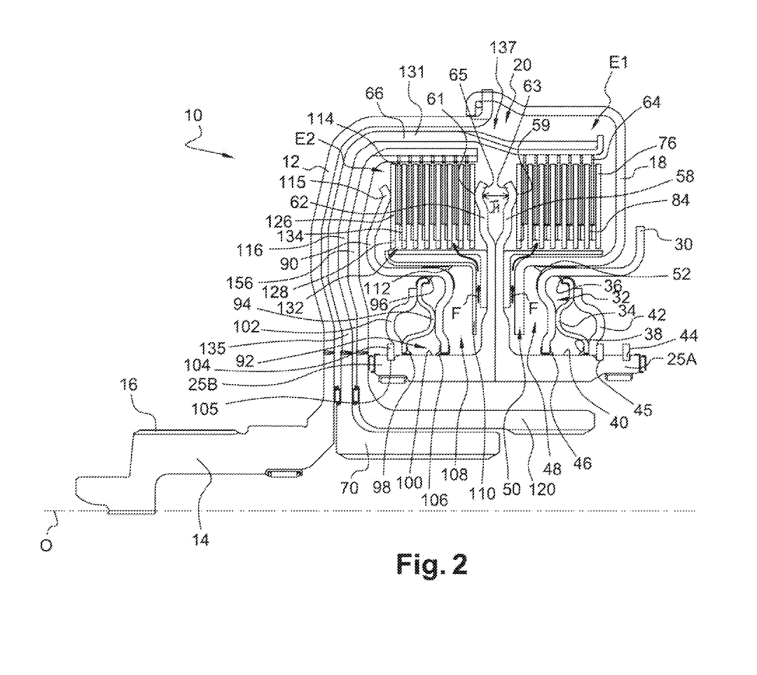

FIGS. 1 and 2 depict an exemplifying embodiment of a transmission system 10, in particular for a motor vehicle, having a rotation axis O.

Transmission system 10 has, around axis O, at least one input element that is rotationally connected to a driving shaft (not depicted).

The input element of system 10 preferably has at least one input shell 12 that is rotationally connected to an input hub 14.

Input shell 12, having an overall L-shape, has a radially oriented part connected by an elbow to an axially oriented part.

Hub 14 has a radially oriented part and an axially oriented part, hub 14 being arranged radially internally with respect to shell 12.

The axially oriented part of hub 14, located inside the radial portion, extends axially rearward in a direction corresponding to that of the engine.

Hub 14 has splines 16, configured in the outer cylindrical surface of the axial portion, for rotational connection of the input element, constituted at least by shell 12 and hub 14, to the driving shaft.

The internal end of the radial portion of shell 12 and the external end of the radial portion of input hub 14 are integral, preferably fastened together by welding.

As a variant, the internal end of the radial portion of input shell 12 and the external end of the radial portion of input hub 14 are fastened together by riveting.

Input hub 14 is, for example, rotationally connected by means of splines 16 to the output of a damping device or damper (such as a dual mass flywheel), the input of which is connected, in particular by means of an engine flywheel, to the driving shaft constituted by a crankshaft that is caused to rotate by an engine that is part of the motor vehicle.

Input shell 12 is caused to rotate by the engine by means of input hub 14.

Input shell 12 is rotationally connected to a drive web 18, said drive web 18 rotationally connecting said input shell 12 to a double wet clutch mechanism 20.

Input shell 12 and drive web 18 are rotationally connected by positive interaction.

Input shell 12 has, at its axially oriented outer radial end, tabs 17 that extend radially outward and interpenetrate with tabs 19 that drive web 18 has at its axially oriented outer radial end.

Tabs 19 of drive web 18 extend radially inward and are offset angularly with respect to tabs 17 so as to become axially inserted, circumferentially, between two consecutive tabs 17 of input shell 12.

An annular circlip 21 is received axially between tabs 17 of input shell 12 and tabs 19 of drive web 18.

Double wet clutch mechanism 20 is controlled to selectively couple said driving shaft to a first driven shaft A1 and to a second driven shaft A2.

First driven shaft A1 and second driven shaft A2 are preferably coaxial.

Double wet clutch mechanism 20 has at least a first clutch E1 and a second clutch E2 that are respectively of the multiple-disc type.

First driven shaft A1 is caused to rotate when said first clutch E1 is closed, and second driven shaft A2 is caused to rotate when said second clutch E2 is closed, said first and second driven shafts A1, A2 being respectively connected to a gearbox that is part of the motor vehicle.

In double wet clutch mechanism 20, first clutch E1 serves e.g. both for starting and for engaging the odd-numbered ratios, and second clutch E2 then handles the even-numbered ratios and the reverse gear; as a variant, the ratios handled by said first clutch E1 and second clutch E2 are interchanged.

First clutch E1 is arranged, for example, axially at the front on the gearbox side of input web 14, and second clutch E2 is arranged, for example, axially at the rear on the engine side of input web 14.

First clutch E1 and second clutch E2 alternatively transmit input power (torque and speed) from the driving shaft, which is received by input shell 12 of system 10, to one of the two driven shafts A1, A2 depending on the open or closed state of each of clutches E1 and E2.

Preferably first clutch E1 and second clutch E2 are in the open state, also called “normally open,” and are actuated selectively during operation by a control device (not depicted) in order to transition from the open state to the closed state.

Double wet clutch mechanism 20 is controlled hydraulically by means of a pressurized fluid, generally oil.

In order to selectively control the change of state of first clutch E1 and of second clutch E2 of mechanism 20 of transmission system 10, the control device has at least one control shaft 22 having oil supply channels 24, for example four thereof as depicted in FIG. 1.

Mechanism 20 has at least one hub having radial orifices that are each connected to one of oil supply channels 24.

Said at least one hub is preferably implemented in two portions, a first hub 25A and a second hub 25B respectively associated with first clutch E1 and with second clutch E2.

First hub 25A has two orifices 26 and 27 that are associated with control of first clutch E1 located axially in front, and second hub 25B likewise has two orifices 28 and 29 that are associated with control of second clutch E2 located axially at the rear.

As a variant that is not depicted, said at least one hub is a hub that is common to first clutch E1 and second clutch E2 and is implemented as a single integral part.

First clutch E1 of the multiple-disc type has a piston 30 that is movable axially, here from front to rear, between a disengaged position and an engaged position that correspond respectively to the open and closed states of first clutch E1.

As depicted in FIGS. 1 and 2, piston 30 is controlled as to displacement by means of a control chamber 32 delimited axially by a front face of a inner radial portion of piston 30 and by the rear radial face of a closure part 34.

Closure part 34 carries, at its outer radial end, sealing means 36 that interact with an inner face of an axial portion of piston 30 and, at its inner radial end, sealing means 38 that interact with an outer axial surface 40 of first hub 25A.

Closure part 34 is preferably associated with an abutment part 42 that is axially immobilized by a stop ring 44 mounted in a groove 45 of first hub 25A.

Advantageously, the axial forces associated with pressurization of control chamber 32 are absorbed by abutment part 42 and not by closure part 34 that carries sealing means 36 and 38.

Piston 30 has at its inner radial end sealing means 46 that interact with outer axial surface 40 of first hub 25A when piston 30 is displaced axially between the disengaged and engaged positions by the pressurization of control chamber 32.

Closure part 34 of control chamber 32 of piston 30 has, between its two radial ends carrying sealing means 36 and 38, a convex segment that interacts with the front radial face of the axially opposite piston 30.

The volume of control chamber 32 has an external portion and an internal portion, located radially on either side of said convex segment of closure part 34.

Control chamber 32 is supplied with oil via orifice 27 that passes radially through first hub 25A, orifice 27 effecting communication between said control chamber 32 and one of oil supply channels 24.

Control chamber 32 of piston 30 of first clutch E1 is associated with a compensating chamber 48 delimited at least by a compensating piston 50.

Advantageously, drive web 18 constitutes compensating piston 50 of first clutch E1.

Drive web 18 thus has a dual function: on the one hand transmitting input power, and on the other hand as a compensating piston in the operation of first clutch E1.

More precisely, the function as compensating piston 50 of first clutch E1 is provided principally by the inner radial portion of said web 18.

As a variant, compensating piston 50 and drive web 18 are implemented in the form of two separate parts.

Compensating chamber 48 of first clutch E1 is delimited axially by the front radial face of compensating piston 50 constituted by the inner radial portion of drive web 18 and by the rear radial face of piston 30.

Compensating chamber 48 is supplied with oil via orifice 26 that first hub 25A comprises.

Sealing of compensating chamber 48 is provided radially externally by sealing means 52 that are carried by piston 30 and that interact with the inner face of an axial portion of compensating piston 50 constituted by drive web 18.

Piston 30 of first clutch E1 extends radially between control chamber 32 located axially at the front, and compensating chamber 48 located axially at the rear.

Piston 30 of first clutch E1 has, at its external radial end, an actuating portion constituted by fingers 54 that extend axially toward the rear in order to act on a multiple-disc assemblage of first clutch E1.

Advantageously, drive web 18 has openings 56 for axial passage of said fingers 54 that constitute the actuating portion of piston 30 of clutch E1.

Piston 30 is controlled to cause axial clamping, in the engaged position, of said multiple-disc assemblage of first clutch E1 against reaction means 60.

In transmission system 10 depicted in FIGS. 1 and 2, first clutch E1 and second clutch E2 of said double wet clutch mechanism 20 are axially juxtaposed, first clutch E1 and second clutch E2 being arranged axially on either side of said reaction means 60.

Said reaction means 60 have at least a first reaction element 58 and a second reaction element 62 that, associated respectively with first clutch E1 and with second clutch E2, are separated axially from one another by a clearance J1.

Advantageously, first reaction element 58 and second reaction element 62 are separated axially from one another by an empty space corresponding to said clearance J1.

Thanks to the axial clearance J1, first reaction element 58 and second reaction element 62 are free to move axially independently of one another.

Advantageously, any risk of interaction between first reaction element 58 of first clutch E1 and second reaction element 62 of second clutch E2 during the operation of mechanism 20 is eliminated.

First reaction element 58 has a reaction face 59 oriented toward the front toward first clutch E1, and second reaction element 62 has a reaction face 61 oriented toward the rear toward second clutch E2.

In the embodiment depicted in the Figures, first reaction element 58 and second reaction element 62 are implemented in the form of at least two separate parts.

“At least two separate parts” is understood to mean that first reaction element 58 and second reaction element 62 are parts that are independent of one another, at least until said elements 58, 62 are assembled within double wet clutch mechanism 20.

First reaction element 58 and second reaction element 62 are made, for example, of sheet metal.

As a variant that is not depicted, first reaction element 58 and second reaction element 62 are implemented as a single part, in order to constitute an integral assemblage before assembly.

First reaction element 58 and second reaction element 62, implemented as one or as at least two parts, are rotationally connected to said at least one hub of mechanism 20.

As described previously, said at least one hub is preferably implemented in two portions, respectively first hub 25A and second hub 25B.

As a variant that is not depicted, said at least one hub is implemented as a single integral part.

First reaction element 58 and second reaction element 62 are preferably connected rotationally to said at least one hub, such as one common hub or two hubs 25A and 25B, by welding.

As a variant, first reaction element 58 and second reaction element 62 are rotationally connected to said at least one hub, such as one common hub or two hubs 25A and 25B, by riveting.

Advantageously, said at least one hub, as a single part or in two portions 25A, 25B, is independent of said reaction elements 58 and 62 so that in particular it can be made of a material different from that utilized for reaction elements 58 and 62 in accordance with a selected production method.

As a variant that is not depicted, first reaction element 58 is implemented as a single part with said first hub 25A of first clutch E1, and second reaction element 62 is implemented as a single part with said second hub 25B of second clutch E2.

First reaction element 58 and second reaction element 62 have at least one abutment boss that is convex and extends axially toward the multiple-disc assemblage of that one of said first and second clutches E1, E2 with which the reaction element is associated.

First reaction element 58 has at least one abutment boss 63 whose front radial face constitutes said reaction face 59.

Second reaction element 62 has at least one abutment boss 65 whose rear radial face constitutes said reaction face 61.

Abutment bosses 63 and 65 are obtained, for example, by stamping of said reaction elements 58 and 62.

Preferably, said at least one abutment boss 63 of first reaction element 58 and said at least one axial abutment boss 65 of second reaction element 62 are located radially on the same radius with respect to axis O.

First reaction element 58 and second reaction element 62 are circumferentially continuous so as to form a disc.

As a variant that is not depicted, first reaction element 58 and second reaction element 62 have at least one circumferentially discontinuous outer radial portion that is constituted by a plurality of reaction arms.

According to this variant, reaction element 58, 62 preferably has a circumferentially continuous inner radial portion constituted by a ring, in particular for rotational connection of said reaction element to said at least one hub 25A, 25B supporting it.

In such a variant, the reaction arms extend radially outward from the annular inner radial portion, and each reaction arm is separated from the adjacent reaction arm by a radial slot.

The reaction arms according to this variant advantageously have abutment bosses 63 and 65 respectively carrying reaction faces 59 and 61.

Advantageously, first reaction element 58 and second reaction element 62, separated axially by the clearance J1, have stiffening means in order to stiffen them and to limit axially the deflection of first reaction element 58 and of second reaction element 62.

Stiffening means of this kind are constituted, for example, by indentations implemented in first reaction element 58 and in second reaction element 62, radially below abutment bosses 63 and 65.

First clutch E1 and second clutch E2 of said double wet clutch mechanism 20 are actuated axially in opposite directions, i.e. axially from front to rear against face 59 for piston 30 of first clutch E1, and axially from rear to front against face 61 for that of second clutch E2.

The multiple-disc assemblage of first clutch E1 has at least friction discs 64 that are rotationally connected to said first driven shaft A1 by an external disc carrier 66. External disc carrier 66 constitutes the output element of first clutch E1.

External disc carrier 66 has at the external radial periphery an axial extension 131 that is equipped with a tooth set 67 intended to interact with a complementary tooth set 68 that each friction disc 64 comprises at its external radial periphery.

External disc carrier 66 constitutes the output element of first clutch E1 and has a radial extension 135 and axial extension 131. According to the invention, axial extension 131 of external disc carrier 66 exhibits a radial offset 137.

Advantageously, radial offset 137 is oriented toward the interior of disc carrier 66.

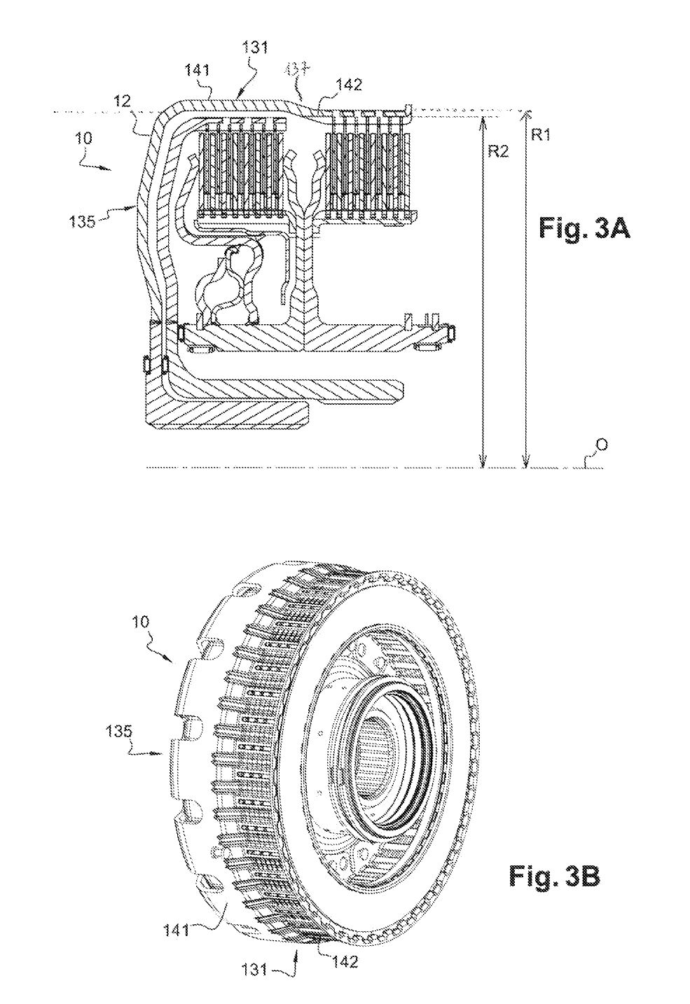

Axial extension 131 has a first portion 141 located in proximity to radial extension 135, and a second portion 142 located remotely from radial extension 135. First portion 141 and second portion 142 are inscribed respectively in a first cylinder and in a second cylinder. According to the invention, the radius R1 of the first portion is larger than the radius R2 of the second portion. The radius R1 corresponds to a minimum radius of the first potion, and the radius R2 corresponds to a minimum radius of the second portion or an internal radius of tooth set 67. According to a first embodiment of the invention (FIGS. 3A and 3B), first portion 141 and second portion 142 are constituted by a single part. First portion 141 and second portion 142 are arranged in such a way that axial extension 131 has locally a section of substantially frustoconical shape 137. On either side of this frustoconical section, the remainder of axial extension 131 extends along an axis substantially parallel to rotation axis O. The section of frustoconical shape 137 is arranged in such a way that it tapers with increasing distance from radial extension 135.

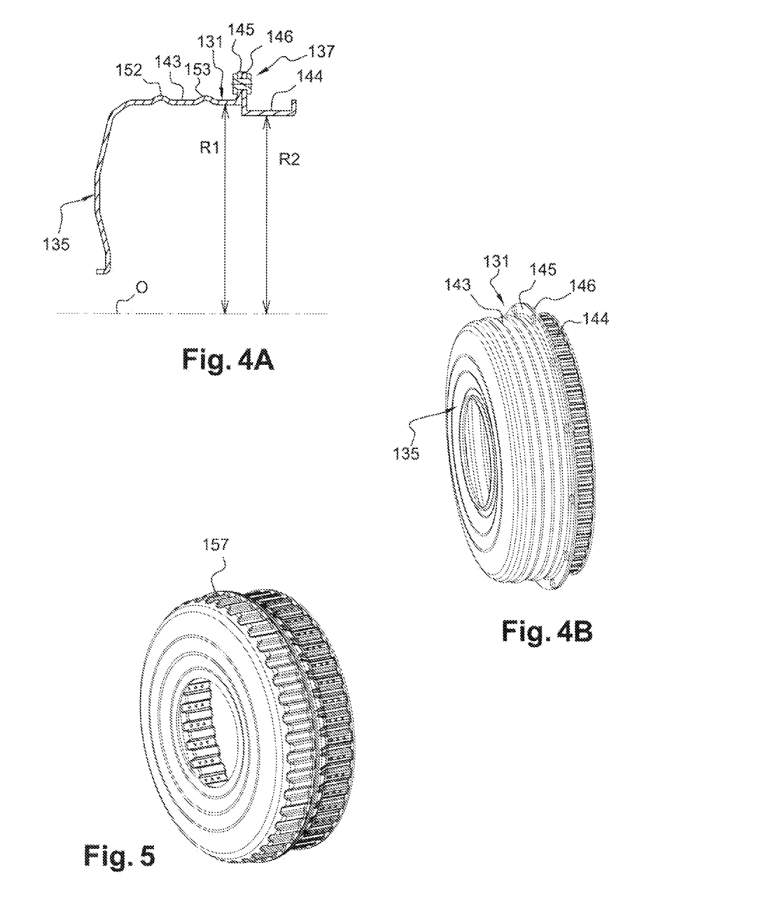

According to a second embodiment (FIGS. 4A and 4B), axial extension 131 has a first portion 143 and a second portion 144 that are separate from one another. First portion 143 is shaped continuously with radial extension 135. First portion 143 and second portion 144 are connected rotationally by riveting.

In this example, one of the ends of each of portions 143 and 144 constitutes a radial collar respectively 145 and 146 that is at least partly peripheral. The two portions 143 and 144 are rotationally connected by connecting the two collars 144 and 146 to one another. They are attached to one another with a radial offset of second portion 144 with respect to first portion 142 before being riveted.

First portion 142 and second portion 144 could be welded to one another.

Collars 145 and 146, constituted respectively by the end of portion 143 and the end of portion 144, can each be inclined in such a way as to constitute a connection of globally frustoconical shape, as in the example according to the first embodiment (FIGS. 3A, 7B).

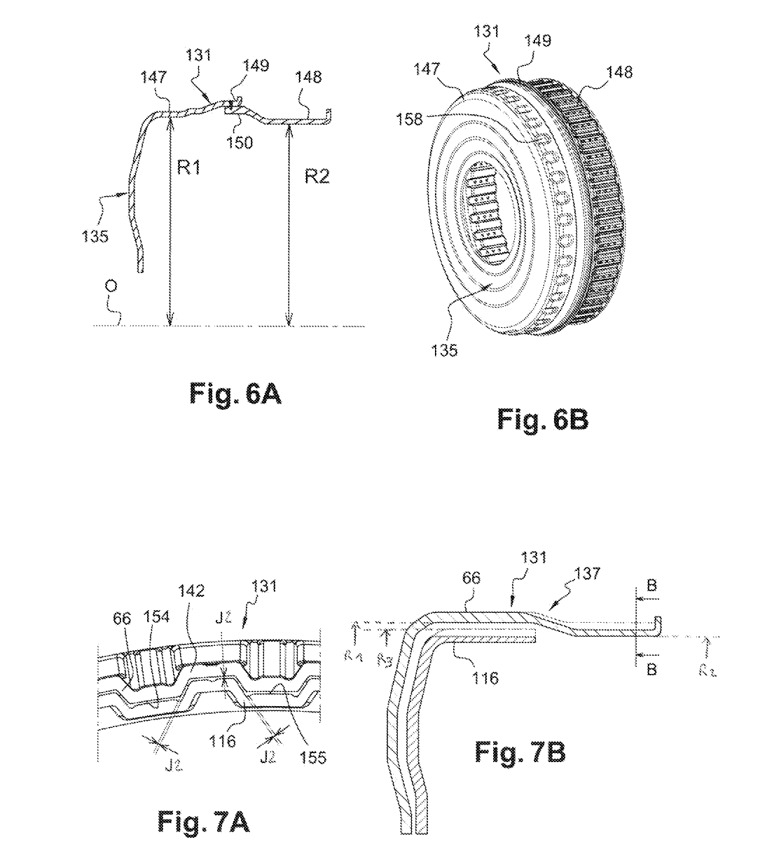

According to a third embodiment of the invention (FIGS. 6A and 6B), axial extension 131 has a first portion 147 and a second portion 148. One of the ends of each of portions 147 and 148 constitutes an axial peripheral rim respectively 149 and 150. Portions 147 and 148 are rotationally connected to one another by radial offset of second portion 148 with respect to first portion 147, and by superposition of axial peripheral rim 149 and peripheral rim 150 onto one another. Preferably the two peripheral rims 149 and 150 are welded to one another.

In the same manner as previously, axial peripheral rim 149 and axial peripheral rim 150 can also be configured in such a way that the connection between first portion 147 and second portion 148 has a shape that is globally frustoconical in section, as for the examples illustrated in FIGS. 3A and 7B.

In FIGS. 4A, 4B, axial extension 131 can exhibit at least one stiffening means 152, 153 in order to stiffen external disc carrier 66. In the example illustrated in FIGS. 4A and 4B, two local deformations such as 152, 153 extend at least partly over the peripheral contour of said axial extension 131.

Each deformation can be a localized shape extending in a direction opposite from axis O, or else toward axis O.

FIG. 5 illustrates another variant of disc carrier 66 of the first clutch having a first portion exhibiting splined shapes 157.

The localized deformations such as those illustrated at 152, 153 in FIGS. 4A, 4B, or at 157 in FIG. 5, can also be constituted by each of the axial extensions that are illustrated in the other embodiments of the invention in FIGS. 1, 2, 3A, 3B, 6A, 6B, 7A, and 7B.

External disc carrier 66 has three radial holes, circumferentially distributed in said axial portion equipped with tooth set 67, and intended for passage of the oil introduced into the multiple-disc assemblage of first clutch E1.

External disc carrier 66 is rotationally connected by meshing to friction discs 64, and by a splined connection to said first driven shaft A1.

External disc carrier 66 has an output hub 70 that extends axially and has, radially internally, axial splines 72 that mesh with complementary splines 73 of first driven shaft A1.

External disc carrier 66 has an overall L-shape, the internal radial end of which, opposite tooth set 67, is integral with output hub 70.

External disc carrier 66 and output hub 70 are preferably fastened together by welding, as a variant by riveting.

Friction discs 64 each have a friction lining 74 on their respective front and rear axially opposite radial faces.

The multiple-disc assemblage of first clutch E1 has flanges 76 that are equipped at their inner radial periphery with a tooth set 78 in order to rotationally connect them to an internal disc carrier 80.

Internal disc carrier 80 has at its outer radial end an axial portion having an outer tooth set 82 that, in complementary fashion, meshes with inner tooth set 78 of each of flanges 76 in order to rotationally connect them with zero clearance.

Internal disc carrier 80 has radial holes (not depicted), distributed circumferentially in said axial portion equipped with tooth set 82, and intended for passage of the oil introduced into the multiple-disc assemblage of first clutch E1.

Friction discs 64 are, in individual fashion, interposed axially between two successive flanges 76. Each of the friction linings 74 of one of friction discs 64 interacts, in an engaged position, with one of the radial faces of flanges 76 arranged axially on either side (at the front and at the rear) of said friction disk 64.

The multiple-disc assemblage of first clutch E1 has, axially, a flange 76 at each of its ends, respectively a front flange 76 whose front radial face is intended to interact, in an engaged position, with fingers 54 that constitute the actuating portion of piston 30; and a rear flange 76 whose rear radial face is intended to interact with front face 59 of reaction element 58 of reaction means 60.

First clutch E1 has resilient return means for automatically returning piston 30 into a disengaged position corresponding to an open state of the clutch.

The resilient return means for piston 30 are preferably constituted by resilient washers, such as spring washers of the “Onduflex” (registered trademark) type.

The resilient washers are interposed axially between flanges 76 and are arranged radially inside friction discs 64, below friction linings 74. Each resilient washer abuts axially against the rear radial face of a flange 76 and against the front radial face of another axially adjacent flange 76.

The resilient return means impinge axially on flanges 76 and, by so doing, facilitate the release of friction discs 64 and the return of piston 30 to the disengaged position.

As a variant that is not depicted, the piston return means of a clutch are constituted by at least one spring that is arranged, for example, radially between axis O and internal disc carrier 80 in order to automatically return piston 30 toward the disengaged position.

For direct transmission of input power, double wet clutch mechanism 20 has connecting means that, for first clutch E1, connect at least drive web 18, internal disc carrier 80, and reaction means 60 with zero axial clearance.

When drive web 18 and compensating piston 50 are, as a variant, implemented as two separate parts, the connecting means then likewise advantageously connect said compensating piston 50 to drive web 18, to internal disc carrier 80, and to reaction means 60 with zero axial clearance.

When compensating piston 50 of first clutch E1 is constituted by drive web 18, mechanism 20 has one less part; the advantages are, in particular, less cost and greater simplicity and axial compactness.

The connecting means are preferably implemented by riveting by means of rivets 85. As a variant that is not depicted, the connecting means are implemented by welding, in particular by transmission laser welding.

Drive web 18 has indentations 86 that are circumferentially distributed and project axially rearward with respect to the rear radial face of drive web 18 that constitutes compensating piston 50.

Indentations 86 each surround a hole intended for axial passage of one of rivets 85 that constitute said connecting means.

Rivets 85 that constitute the connecting means are preferably common to first clutch E1 and to second clutch E2, which will now be described.

As a variant, mechanism 20 has at least two series of separate rivets to constitute the connecting means: first rivets associated with first clutch E1, and second rivets associated with second clutch E2.

Second clutch E2 of double wet clutch mechanism 20 of transmission system 10 is similar in design to first clutch E1, second clutch E2 being of the multiple-disc type.

The detailed description provided above of first clutch E1 may advantageously be consulted as necessary for a description of second clutch E2.

Second clutch E2 has a piston 90 that is axially movable (here from rear to front) between a disengaged position and an engaged position corresponding respectively to the open and closed states of second clutch E2 of mechanism 20.

Piston 30 of first clutch E1 and piston 90 of second clutch E2 of said double wet clutch mechanism 20 travel axially in opposite directions in order to transition, for example, from the disengaged position to the engaged position.

Piston 90 of second clutch E2 is controlled as to displacement by means of a control chamber 92 delimited axially by a rear face of an internal radial portion of piston 90 and by the front radial face of a closure part 94.

Control chamber 92 is selectively supplied with oil through orifice 29 that passes radially through second hub 25B and is connected to one of supply channels 24 of control shaft 22.

Closure part 94 has, at its outer radial end, sealing means 96 that interact with an inner face of an axial portion of piston 90 and, at its inner radial end, sealing means 98 that interact with an outer surface 100 of second hub 25B.

Surface 100 associated with second clutch E2 is located axially rearward with respect to reaction means 60 arranged between said clutches E1 and E2, i.e. axially opposite surface 40 associated with piston 30 of first clutch E1.

Closure part 94 is preferably associated with an abutment part 102 that is axially immobilized by a stop ring 104 mounted in a groove 105 of second hub 25B.

Piston 90 has, at its inner radial end, sealing means 106 that interact with outer surface 100 of second hub 25B when piston 90 is displaced axially between the disengaged and engaged positions by the pressurization of control chamber 92.

Like closure part 34 for first clutch E1, closure part 94 is configured, globally between its radial ends carrying sealing means 96 and 98, to come into axial interaction with the rear radial face of piston 90.

Control chamber 92 is associated with a compensating chamber 108 delimited by at least one compensating piston 110. Compensating chamber 108 is supplied with oil via one of supply channels 24, through orifice 28 implemented in second hub 25B.

As compared with compensating piston 50 of first clutch E1 which is constituted by drive web 18, compensating piston 110 of second clutch E2 is a separate part.

Compensating chamber 108 is delimited axially by the rear radial face of compensating piston 110 and by the front radial face of piston 90.

Sealing of compensating chamber 108 is provided radially externally by sealing means 112 that are carried by piston 90 and that interact with the inner face of an axial portion of compensating piston 110.

The inner radial portion of piston 90 extends radially between control chamber 92 located axially at the rear, and compensating chamber 108 located axially at the front.

Piston 90 of second clutch E2 has, at its external radial end, an actuating portion 115 constituted by a boss that extends axially to the front toward a multiple-disc assemblage of second clutch E2.

Actuating portion 115 of piston 90 of second clutch E2 is circumferentially continuous; and, as a variant, discontinuous.

The actuating portion constituted by fingers 54 of piston 30 of first clutch E1, and actuating portion 115 of piston 90 of second clutch E2 of said mechanism 20, are located radially on one radius centered on axis O of system 10.

Advantageously, the actuating portions of pistons 30 and 90 are located on the same radius, centered on axis O, as the apical portion of abutment bosses 63 and 65 that constitute reaction faces 59 and 61.

Piston 30 of first clutch E1 and piston 90 of second clutch E2 each apply a clamping force onto the multiple-disc assemblage associated with them, along the axial direction but in opposite directions, the reaction occurring on reaction elements 58 and 62 likewise being opposite.

The multiple-disc assemblage of second clutch E2 has friction disks 114 that are rotationally connected to second driven shaft A2 by an external disc carrier 116 that constitutes the output element of clutch E2.

External disc carrier 116 has at the external radial periphery an axial extension 151 that is equipped with an inner tooth set 117 intended to interact with an outer tooth set 118 that each of friction discs 114 comprises.

External disc carrier 116 has radial holes, distributed circumferentially in said axial portion equipped with tooth set 117, and intended for passage of the oil introduced into the multiple-disc assemblage of second clutch E2.

External disc carrier 116 is rotationally connected by meshing to friction discs 114, and by a splined connection to said second driven shaft A2.

External disc carrier 116 has an output hub 120 that extends axially and has, radially internally, splines 122 that mesh with complementary splines 123 of second driven shaft A2.

Said disc carrier 116 and output hub 120 are preferably fastened together by welding; and, as a variant, by riveting.

Friction discs 114 each have a friction lining 124 on their respectively front and rear axially opposite radial faces.

In the example in FIGS. 1 and 2, external disc carrier 116 is received inside external disc carrier 66. More precisely, disc carrier 116 is received inside first portion 141, 143, 147 of axial extension 131 (FIGS. 3A, 4A, 6A).

In FIGS. 7A and 7B, external disc carrier 66 and external disc carrier 66 are arranged with respect to one another with a clearance J2. This clearance J2 is calculated so that tooth set 67 of external disc carrier 66 can slide without rubbing onto the complementary tooth set 117 of external disc carrier 116 at the time of assembly.

The clearance J2 is measured perpendicularly between an inner face 154 of tooth set 67 of second portion 142 of axial extension 131 of external disc carrier 66 and an outer face 155 of tooth set 117 of axial extension 151 of external disc carrier 116.

In other words, the radius R2 of second portion 141 is calculated to be reduced by a value just sufficient to create clearance J2, and to allow external disc carrier 66 to travel onto external disc carrier 116 without rubbing.

As illustrated in FIG. 7B, axial extension 151 of external disc carrier 116 defines a maximum radius R3 on its external perimeter.

According to the invention, the radius R3 defined by axial extension 151 is larger than the radius R2 of the second portion of extension 131.

In an embodiment, the radius R3 is between radius R1 and radius R2.

The multiple-disc assemblage of second clutch E2 has flanges 126 that are equipped at their inner radial periphery with a tooth set 128 in order to connect them rotationally to an internal disc carrier 130.

Internal disc carrier 130 has at its outer radial end an axial portion having an outer tooth set 132 that meshes with inner tooth set 128 of each of flanges 126 in order to rotationally connect them with zero clearance.

Internal disc carrier 130 has radial holes, distributed circumferentially in said axial portion equipped with tooth set 132, and intended for passage of the oil introduced into the multiple-disc assemblage of second clutch E2.

Friction discs 114 are, in individual fashion, interposed axially between two successive flanges 126.

Each of the friction linings 124 of one of friction discs 114 interacts, in an engaged position, with a radial face of one of the two flanges 126 arranged axially on either side.

The multiple-disc assemblage of second clutch E2 has, axially, a flange 126 at each of its ends, respectively a rear flange 126 whose rear radial face is intended to interact, in an engaged position, with actuating part 115 of piston 90, and a front flange 126 whose front radial face is intended to interact with rear face 61 of reaction element 62.

Second clutch E2 has resilient return means 134 for automatically returning piston 90 into a disengaged position corresponding to an open state of the clutch.

Preferably, and as for first clutch E1, resilient return means 134 for piston 90 are constituted by resilient wave spring locking washers, such as spring washers of the Onduflex® type.

For direct transmission of input power, double wet clutch mechanism 20 has connecting means that, for second clutch E2, connect at least compensating piston 110, internal disc carrier 130 of second clutch E2, and said reaction means 60 with zero axial clearance.

Advantageously, the connecting means of second clutch E2 are implemented by riveting.

Said connecting means of second clutch E2 are preferably constituted by rivets 85 that are shared with first clutch E1, so that said connecting means are constituted only by rivets 85.

As depicted in FIG. 1, the connecting means of double wet clutch mechanism 20 are arranged axially between piston 30 of first clutch E1 and piston 90 of second clutch E2.

The connecting means connect, with zero axial clearance, at least said drive web 18, internal disc carrier 80 of first clutch E1, internal disc carrier 130 of second clutch E2, and said at least one hub carrying reaction means 60 constituted by reaction elements 58 and 62.

In this embodiment, rivets 85 connect first hub 25A and second hub 25B rotationally and with zero axial clearance.

Rivets 85 that constitute the connecting means allow drive web 18 to be connected simultaneously both to first clutch E1 and to second clutch E2 of the mechanism, and allow direct transmission of the input power delivered to system 10 by the driving shaft.

The connecting means constituted by rivets 85 are preferably used to ensure fastening of compensating piston 50 of first clutch E1, constituted here by web 18, and of compensating piston 110 of second clutch E2.

Advantageously, said connecting means also connect compensating piston 50 of first clutch E1 and compensating piston 110 of second clutch E2 of mechanism 20 with zero axial clearance.

Reaction elements 58 and 62 are interposed axially between internal disc carrier 80 of first clutch E1 and internal disc carrier 130 of second clutch E2 for direct transmission of input power to mechanism 20.

Like drive web 18 that constitutes compensating piston 50 of first clutch E1, compensating piston 110 of second clutch E2 has indentations 136 that each surround a hole 138 for the passage of one of rivets 85 that constitute the connecting means.

When compensating piston 50, as a variant, is a separate part from drive web 18, compensating piston 50 is then also advantageously connected with zero axial clearance by rivets 85 in order to be kept in position.

The connecting means constituted by rivets 85 nevertheless do not impede oil circulation radially from inside to outside, intended in particular to lubricate friction linings 74 and 124 of clutches E1 and E2.

Indentations 86 of web 18 that constitutes compensating piston 50, like indentations 136 of compensating piston 110, are circumferentially discontinuous.

As depicted in FIG. 2, thanks to indentations 86 an axial clearance exists between the rear radial face of compensating piston 50 constituted by web 18 and the front radial face of internal disc carrier 80, allowing radial circulation of oil to the multiple-disc assemblage of first clutch E1.

Advantageously, oil passages are thus configured to allow oil circulation radially outward at the level of the connecting means constituted by rivets 85.

The oil circulates, radially from inside to outside according to the arrows depicted in particular in FIG. 2, utilizing radial oil passages F delimited circumferentially by two consecutive indentations 86 of web 18 that constitutes compensating piston 50 of first clutch E1, or by two circumferentially consecutive indentations 136 of compensating piston 110 of second clutch E2.

For first clutch E1, the oil flow then passes radially through holes of internal disc carrier 80 and circulates between friction discs 74 and flanges 76 of the multiple-disc assemblage of E1 before passing through the radial holes of external disc carrier 66.

For second clutch E2, the oil flow passes radially through holes of internal disc carrier 130 and circulates between friction disks 114 and flanges 126 of the multiple-disc assemblage of E2 before passing through the radial holes of external disc carrier 116.

When the connecting means are implemented by riveting, sealing of compensating chamber 48 of first clutch E1 is provided, around the holes, by contact between a radially planar annular face 142 that is constituted as a result of recess 86 and surrounds hole 88.

Once riveting has been performed in order to axially connect the parts together, said annular face interacts with a segment of the planar radial face surrounding the hole of internal disc carrier 80.

Sealing of compensating chamber 108 of second clutch E2 is provided, around the holes, by contact between a radially planar annular face that is constituted as a result of recess 136 and surrounds the hole.

Once riveting has been performed in order to axially connect the parts together, said annular face interacts with a segment of the planar radial face surrounding the hole of internal disc carrier 130.

Openings 158 can also be provided on axial extension 131 of each of the embodiments of the invention (FIGS. 3A, 3B, 4A, 4B, 5, 7A, 7B). An example of such openings 158 is illustrated in FIG. 6B. Such openings also contribute to reducing the inertia of assemblage 10.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

1. A double wet clutch mechanism (20) for a transmission system (10), especially for a motor vehicle, having around a rotation axis (O) at least a first clutch (E1) and a second clutch (E2) respectively of the multiple-disc type, the first clutch (E1) having at least a first piston (30) and the second clutch (E2) having at least a second piston (90), said first and second pistons (30, 90) being displaced axially in opposite directions in order to cause, in an engaged position, clamping of a multiple-disc assemblage against reaction means (60) that are interposed axially between the multiple-disc assemblage of each of said first and second clutches (E1, E2), said multiple-disc assemblage of the first clutch (E1) and of the second clutch (E2) respectively having friction discs (64, 114) that are rotationally connected respectively to the first driven shaft (A1) and to the second driven shaft (A2) respectively by an external disc carrier (66, 116) that constitutes the output element of the clutch (E1, E2), each of said external disc carriers having a radial extension (135, 156) and an axial extension (131, 151), the axial extension of at least one of said external disc carriers exhibiting a radial offset (137), wherein the axial extension (131) of the external disc carrier of the first clutch has a first portion (141) and a second portion (142) arranged in such a way that the axial extension (131) locally has a section of frustoconical shape (137), the section of frustoconical shape (137) being arranged in such a way that it decreases with increasing distance from the radial extension (135).

2. The mechanism according to claim 1, in which the external disc carrier (116) of the second clutch is received inside the external disc carrier (66) of the first clutch, the external disc carrier of the first clutch having said axial extension (131) with the radial offset.

3. The mechanism according to claim 1, in which the axial extension of the external disc carrier, exhibiting an axial offset, has a first portion (141, 143, 147) and a second portion (142, 144, 148) each inscribed respectively within a first cylinder and within a second cylinder, the radius R1 of the first portion being larger than the radius R2 of the second portion.

4. The mechanism according to claim 3, in which the first portion and the second portion form a single part.

5. The mechanism according to claim 3, in which the first portion and the second portion each constitute a separate part, said portions being rotationally connected, for example by welding or riveting.

6. The mechanism according to claim 5, in which an end of the first portion (143) and an end of the second portion (144) each constitute a radial collar (145, 146), the collar of the first portion and the collar of the second portion being rotationally connected to one another.

7. The mechanism according to claim 5, in which an end of the first portion (147) and an end of the second portion (148) each constitute a peripheral rim (149, 150) extending axially, the peripheral rim of the first portion and the peripheral rim of the second portion being rotationally connected to one another by superposition of their respective peripheral rims.

8. The mechanism according to claim 3, in which the radius R2 of the second portion is reduced to a value corresponding to a clearance J measured between the two external disc carriers at the location of the second portion of the axial extension, the clearance J being sufficient to permit one of the external disc carriers to slide onto the other of the external disc carriers during assembly.

9. The mechanism according to claim 1, in which the axial extension of the external disc carrier has at least one stiffening means (152, 153, 157) for stiffening said extension.

10. The mechanism according to claim 9, in which said axial extension constitutes at least one local deformation (152, 153) extending in a direction opposite to the rotation axis.

11. The mechanism according to claim 10, in which the local deformation is at least partly annular.

12. The mechanism according to claim 9, in which the axial extension has a splined outer peripheral surface.

13. The mechanism according to claim 1, in which the axial extension has at least one opening (158).

14. The mechanism according to claim 2, in which the axial extension of the external disc carrier, exhibiting an axial offset, has a first portion (141, 143, 147) and a second portion (142, 144, 148) each inscribed respectively within a first cylinder and within a second cylinder, the radius R1 of the first portion being larger than the radius R2 of the second portion.

15. The mechanism according to claim 4, in which the radius R2 of the second portion is reduced to a value corresponding to a clearance J measured between the two external disc carriers at the location of the second portion of the axial extension, the clearance J being sufficient to permit one of the external disc carriers to slide onto the other of the external disc carriers during assembly.

16. The mechanism according to claim 5, in which the radius R2 of the second portion is reduced to a value corresponding to a clearance J measured between the two external disc carriers at the location of the second portion of the axial extension, the clearance J being sufficient to permit one of the external disc carriers to slide onto the other of the external disc carriers during assembly.

17. The mechanism according to claim 6, in which the radius R2 of the second portion is reduced to a value corresponding to a clearance J measured between the two external disc carriers at the location of the second portion of the axial extension, the clearance J being sufficient to permit one of the external disc carriers to slide onto the other of the external disc carriers during assembly.

18. The mechanism according to claim 7, in which the radius R2 of the second portion is reduced to a value corresponding to a clearance J measured between the two external disc carriers at the location of the second portion of the axial extension, the clearance J being sufficient to permit one of the external disc carriers to slide onto the other of the external disc carriers during assembly.
